(19) United States
(12) Patent Application Publication
(10) Pub. No.: US 2009/0105431 A1
(43) Pub. Date: Apr. 23, 2009

(54) PROCESS FOR PREPARATION OF PASTABLE POLYMERS

(75) Inventors: Heinz Bankholt, Dorsten (DE); Jan-Stephan Gehrke, Marl (DE); Kurt Muller, Dulmen (DE); Axel Stieneker, Munster (DE); Michael Trager, Haltern am See (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: VESTOLIT GMBH & CO. KG, Marl (DE)

(21) Appl. No.: 11/908,988

(22) PCT Filed: Feb. 17, 2006
(86) PCT No.: PCT/EP2006/001428

§ 371 Date: Jun. 2, 2008

(30) Foreign Application Priority Data
Mar. 18, 2005 (EP) 05005927.8

(51) Int. Cl. C08F 2/01

(52) U.S. Cl. 526/88

(57) ABSTRACT

The present invention relates to a single-stage batch process for preparation of pastable polymers, in particular of vinyl chloride homo- and copolymers, by the microsuspension process, where these in a blend with plasticizers give PVC pastes, also termed plastisols, with very low viscosities and with very low emulsifier contents.

The present invention relates to a single-stage batch process for preparation of pastable polymers, in particular of vinyl chloride homo- and copolymers, by the microsuspension process, where these in a blend with plasticizers give PVC pastes, also termed plastisols, with very low viscosities and with very low emulsifier contents.

It is known that vinyl chloride homo- and copolymers intended for production of plastisols can be prepared by the continuous and batch process.

The processability of plastisols is decisively influenced by paste viscosity. For most applications (coating processes, e.g. spreading, printing, and also processing via dipping and via casting), low paste viscosity is advantageous for increasing productivity. Other advantages of low paste viscosity are that the amounts of processing aids which give rise to emissions can be reduced, possibly to zero, in formulations with low plasticizer content.

Vinyl chloride polymers prepared in the continuous emulsion polymerization process give plastisols with low viscosity in the high shear region and with high viscosity in the low shear region (e.g. DE 1017369, DE 1029563, DD 145171, DE 2714948, DE 1065612, DE 2625149). However, low paste viscosity specifically in the low shear region is advantageous for productivity and product quality in many of the abovementioned processing methods. Vinyl chloride polymers prepared by the continuous process also have very high emulsifier concentrations, which have an adverse effect on properties such as water absorption, migration behavior, and transparency of foils, etc. in the products produced therefrom.

Batch emulsion polymerization can achieve polymerization with markedly lower emulsifier content. The result is achievement of an improvement in the disadvantageous properties induced via high emulsifier contents, e.g. water absorption, migration behavior, and transparency of foils (DE 1964029, BE 656985, DE 2429326). However, vinyl chloride polymers prepared by this process always give not only products with narrow primary particle size distribution but also plastisols whose paste viscosity is markedly higher than when the continuous process is used.

Preparation of pastable vinyl chloride polymers by the microsuspension process is also known, as described by way of example in DE 1069387, DD 143078, DE 3526251. In this process, the monomer-water mixture predispersed by means of a high shear level (homogenization) is polymerized using ionic and nonionic surfactants and initiators to give polymer dispersions with the broad particle size distribution typical of this process. Emulsifiers that can be used here are the ammonium and alkali metal salts of fatty acids, or are surfactants such as alkali metal alkylsulfonates or the corresponding sulfates, alkali metal alkylarylsulfonates, and sulfosuccinic esters in combination with fatty alcohols or with ethoxylated fatty alcohols.

The polymers obtained via this process lead to low-viscosity pastes with relatively high emulsifier contents. The pastes are often observed to be dilatant, and this makes processing of the pastes more difficult in the relatively high shear region.

A fact previously disclosed is that an improvement can be achieved in the rheological properties of plastisols via production of bimodal polymer lattices, prepared by way of emulsion polymerization or microsuspension polymerization (U.S. Pat. No. 6,245,848, U.S. Pat. No. 6,297,316, U.S. Pat. No. 4,245,070).

However, a requirement of the processes mentioned is to prepare the seed latex P1 in a first stage and to prepare the seed latex P2 in a second stage (particle size P1≠P2). A latex with bimodal particle size is then obtained after polymerization in the presence of the two particle populations P1 and P2 via addition of the appropriate seed lattices and vinyl chloride. There is also a previous description (U.S. Pat. No. 6,245,848) of improvement of rheological properties via blending of polymer lattices with different particle size and subsequent drying.

A disadvantage of the multistage processes is high cost for technology and analysis when the process is implemented. The quality of the bimodal latex is decisively determined by the quality of the seed lattices. Shifts in the particle size and in the proportion by weight of one particle population in the seed lattices P1 or P2 are reflected in shifts in particle size or in the content of the particle populations with respect to one another in the bimodal latex, and therefore reflected in the rheological properties of the plastisols. Reproducible preparation and quality control of the seed lattices requires high capital expenditure in respect of metering technology (emulsifier, initiator, monomers), and high analytical cost for determination of the particle sizes of the particle populations P1 and P2.

There are also known processes for preparation of low-viscosity vinyl chloride homo- and copolymers by means of a microsuspension procedure with addition of up to 1% of paraffins (paraffins having >8 carbon atoms) (DD 220317). A disadvantage of this process is that after drying of the latex (preferably spray drying) the paraffins, which are incompatible with the polymer, mostly remain in the polymer and adversely affect its properties in the finished product (fogging in the automobile sector, migration, indoor emission (VOC values) in the floorcovering and wallpaper sector). Secondly, the concentration of the volatile paraffins increases in the residual monomer reclaimed during the monomer-removal process, and complicated distillative separation of the paraffins from the monomer in the monomer-reclamation system is then required.

An object on which the present invention is based is to provide an economically efficient single-stage process which can prepare pastable polymers and copolymers of vinyl chloride via batch polymerization in a microsuspension procedure, and which, after drying and mixing of the resultant polymers with plasticizers, leads to extremely low-viscosity plastisols with very low emulsifier concentrations.

The invention achieves the object via a process for preparation of pastable polymers composed of ethylenically unsaturated monomers by means of batch polymerization or copolymerization in a microsuspension process with use of dispersing equipment using the rotor-stator principle or (any) other homogenizing machine(s), where a bimodal primary particle size distribution of the polymer dispersion is generated via a single-stage process optimized with respect to dispersing pressure and shear gap width of the disperser system.

The result of the single-stage batch polymerization or copolymerization process in a microsuspension procedure, using dispersion equipment using the rotor-stator principle, or using any other homogenizing machine (e.g. a piston pump), via optimization of homogenizing pressure and of the shear gap width of the homogenizer system, is directly to achieve bimodal primary particle size distribution of the resultant polymer dispersion (populations of primary particles: P1 in the range from 0.05-1.0 μm; P2 in the range from 1.5-20 μm), which, after drying and mixing with plasticizers, leads to extremely low-viscosity plastisols with low emulsifier content.

The advantages achieved by the invention are in particular that complicated preparation of seed lattices and their use can be avoided, and also that the polymerization process does not use any additives incompatible with the polymer produced, e.g. paraffins, which bring about disadvantageous processing properties. Furthermore, it is possible to use a markedly smaller amount of emulsifier(s) to stabilize the monomer droplets and, respectively, the polymer dispersion, without any resultant adverse effect on the stability of the latex formed (≧30 min of stability on stirring at 3000 rpm).

Another advantage of the process provided by the invention is that it is not necessary for the entire amount of monomer or comonomer to be fed via the homogenizing equipment into the polymerization tank, but instead a “shot” of material can be directly added to the reactor. This gives shorter feed times and higher space-time yields.

The process on which the invention is based leads to polymer dispersions with almost identical proportions by volume of the populations of different particle size in the dispersion. The plastisols obtained therefrom, with plasticizers after drying of the polymers, have markedly lower paste viscosity in comparison with plastisols derived from microsupsension processes with broad particle size distribution. It is possible to avoid addition of additives for reduction of paste viscosity, e.g. diluents or extenders.

The process of the invention permits setting of a defined distribution by volume of the particle populations P1 and P2 by way of appropriate adjustment of the parameters of pressure and shear gap width in the dispersing apparatus, and thus permits “tailoring” of rheological properties of the plastisols.

To permit ideal utilization of the advantages associated with the inventive process, the volume-average particle diameter of particle population P1 is from 0.05-1.0 μm, preferably from 0.2-0.8 μm, particularly preferably from 0.4-0.7 μm, and the volume-average particle diameter of particle population P2 is from 1.0-20 μm, preferably from 2.0-5.0 μm, particularly preferably from 2.5-4 μm. The separation between the maxima of particle populations P1 and P2 is preferably from 2-5 μm.

The ratio by volume of the particle populations P1 and P2 in the bimodal distribution in the resultant dispersion is in the range from 90:10 to 10:90, preferably in the range from 60:40 to 40:60.

Another advantage of the present process is that the amounts of emulsifier/coemulsifier needed for stabilization of the polymer dispersion are in each case ≦0.8% and thus markedly below the level conventional for microsuspension polymers: in each case from 1.0-1.5%. Despite very low emulsifier/coemulsifier content, the dispersion can be pumped without difficulty and stable in storage (the dispersion having ≧30 min of stability on stirring at 3000 rpm).

A feature of the products produced from the polymers is very low water absorption. Transparent products, in particular foils, also have particularly high transparency. An advantage in applications in particular in the automobile sector is that the low emulsifier contents induce a very low tendency toward “fogging”.

The polymer dispersion prepared as in the present invention can be stabilized by the conventional anionic, cationic, or nonionic emulsifiers, without any restriction of the invention in respect of the emulsifiers used.

In particular, ionic emulsifiers can be used, e.g. the alkali metal or ammonium salts of carboxylic acids having from 10 to 20 carbon atoms, e.g. sodium laurate, sodium myristate, or sodium palmitate.

Other suitable compounds are the primary and secondary alkali metal and, respectively, ammonium alkyl sulfates, e.g. sodium lauryl sulfate, sodium myristyl sulfate, and sodium oleyl sulfate.

The alkali metal or ammonium salts of alkylsulfonic acids which are used as emulsifier component can comprise those whose alkyl radicals contain from 10 to 20 carbon atoms, preferably from 14 to 17 carbon atoms, being branched or unbranched. Examples of those used are: sodium decylsulfonate, sodium dodecylsulfonate, sodium myristylsulfonate, sodium palmitylsulfonate, sodium stearylsulfonate, sodium heptadecylsulfonate.

The alkali metal and ammonium salts of alkylsulfonic acids which can be used as emulsifier component can comprise those whose alkyl chain has from 8 to 18 carbon atoms, preferably from 10 to 13 carbon atoms, being branched or unbranched. Examples which may be mentioned are: sodium tetrapropylenebenzenesulfonate, sodium dodecylbenzenesulfonate, sodium octa-decylbenzenesulfonate, sodium octylbenzenesulfonate, and also sodium hexadecylbenzenesulfonate.

The alkali metal and ammonium salts of sulfosuccinic esters which can be used as emulsifier component can comprise those whose alcohol moiety contains from 6 to 14 carbon atoms, preferably from 8 to 10 carbon atoms, being branched or unbranched. Examples of those which can be used are: sodium dioctyl sulfosuccinate, sodium di-2-ethylhexyl sulfosuccinate, sodium didecyl sulfosuccinate, sodium ditridecyl sulfosuccinate.

Nonionic emulsifiers which can be used are fatty alcohols having from 12 to 20 carbon atoms, e.g. cetyl alcohol, stearyl alcohol, or fatty alcohol-ethylene oxide-propylene oxide adducts, or else alkylphenol polyethylene glycol ethers, e.g. nonylphenol polyethylene glycol ethers.

It is also possible to use mixtures of emulsifiers. It is also possible for additional auxiliaries to be admixed with the emulsifiers mentioned, examples being esters, such as sorbitan monolaurate and glycol carboxylates.

The initiators that can be used in this process are the known organic and inorganic peroxides. Again, there is no inventive restriction on the use of the initiators, and any suitable initiator can be used.

It is preferable to use an alkyl peroxydicarbonate whose alkyl radicals comprise from 2 to 20 carbon atoms, e.g. diethyl peroxydicarbonate, di(2-ethylhexyl) peroxydicarbonate, dicetyl peroxydicarbonate, dimyristyl peroxydicarbonate, or a diacyl peroxide whose acyl radical contains from 4 to 20 carbon atoms, e.g. diisobutyryl peroxide, dilauroyl peroxide, didecanoyl peroxide, or an alkyl, cycloalkyl, aryl, or alkylaryl perester, e.g. cumyl peroxyneodecanoate, tert-butyl peroxyneodecanoate, where the peracyl radical contains from 4 to 20 carbon atoms, or a mixture of the peroxy compounds mentioned.

Preferred inorganic peroxides used are the ammonium and alkali metal peroxodisulfates or hydrogen peroxide.

Comonomers that can be used are styrene, butadiene, acrylonitrile, acrylates and methacrylates, and ethylene, or else a mixture of the compounds mentioned.

The inventive use of a disperser using the rotor-stator principle or of any other homogenizing equipment in particular provides that the process parameters of pressure and gap width of the disperser system are adjusted with respect to one another in such a way as to give bimodal particle size distribution of the emulsifier-stabilized monomer droplets in water directly on passage of the water/monomer/comonomer/emulsifier/initiator mixture through the disperser. Subsequent polymerization gives a polymer dispersion with bimodal particle size distribution. The particle size distribution of the polymer dispersion here is decisively determined by the particle size distribution in water of the monomer droplets obtained after dispersion.

The use of a disperser using the rotor-stator principle has proven particularly suitable for the inventive process. The pressure and shear gap width of the disperser system here can be varied with great precision, thus permitting achievement of the desired result.

Given suitable adjustment of the process parameters on the disperser, the emulsion/dispersion obtained after passage through the disperser system has bimodal particle size distribution of the monomer droplets, where larger and smaller monomer droplets (droplets in which the polymerization reaction then takes place) are present and are stable. A person skilled in the art can use simple sampling and checking of the result described here in order to adjust the process parameters on the disperser.

Suitable particle sizes (diameters) are in the range from 0.05-1.0 μm, for the smaller population (P1), the main population preferably being in the range from 0.2-0.8 μm, particularly preferably from 0.4-0.7, and the diameters of the particles for the larger population (P2) are in the range from 1.5-20 μm, most of the population preferably being in the range from 2.0-5.0 μm, particularly preferably from 2.5-4.0 μm.

The particle size distribution can be adjusted via the process parameters on the disperser and depends to a certain extent on the desired viscosity of the plastisol to be produced from the polymer. The person skilled in the art is aware of the relationship between particle diameters of the primary particles and rheology of the pastable polymers. The desired size and the population ratios of the particles can be varied according to the desired viscosity values in the paste.

Bimodal distribution of the particle sizes leads to a reduction in the viscosity of the resultant dispersion and thus to markedly better processability of the polymer pastes.

It has been found that the polymer dispersions prepared by the process described in the invention with bimodal particle size distribution are also stable during further treatment, e.g. ultrafiltration and spray drying, thus making any further addition of stabilizing emulsifiers unnecessary.

The low paste viscosity of the plastisols prepared from the polymers prepared in the invention makes it possible to avoid addition of viscosity-reducing additives, e.g. diluents or else extenders. The result is that processing of the plastisols to give the final product becomes considerably simpler and less expensive.

### FIGURES

FIG. 1: Micrograph of polymer dispersion from Inventive Example 1 FIG. 1 shows a micrograph of the polymer dispersion obtained from the polymerization of Inventive Example 1. The micrograph shows the bimodal distribution of the polymer dispersion with the two particle populations P1 and P2.

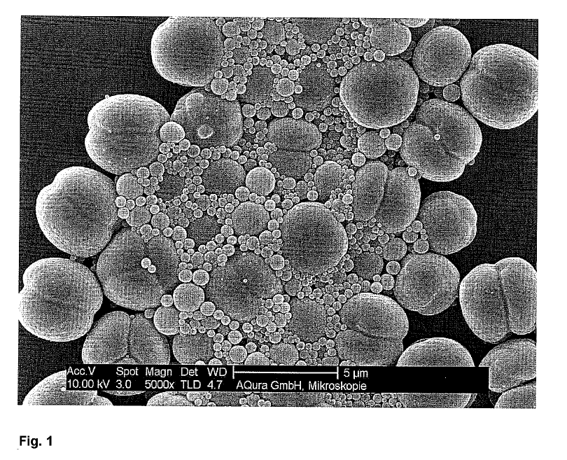

FIG. 2: Differential particle size distribution of polymer dispersions FIG. 2 shows the measured differential particle size distributions of the resultant polymer dispersions. The polymerization reactions were carried out as in the inventive examples described here.

### EXAMPLES

### Inventive Example 1

4400 kg of deionized water were used as initial charge in a 15 m³ stirred vessel. The following were added to this

55 kg of alkylarylsulfonate
55 kg of stearyl monoethylene glycol ether
5.5 kg of dimyristyl peroxodicarbonate
5500 kg of vinyl chloride.

This mixture is stirred for 15 min at 25° C. and then passed under pressure through a rotor-stator disperser using 10.5 bar and a gap width of 0.5 mm in a 15 m³ stirred autoclave. The dispersion time here is 36 min, with throughput of 18 m³/h.

The reaction mixture is heated in the autoclave to the polymerization temperature of 52° C. The polymerization time is about 8 h.

After monomer removal, the dispersion is worked up by way of a spray drier to give polyvinyl chloride powder.

The spray drying conditions are adjusted in such a way that the grain size distribution of the powder comprises <1% by weight of particles >63 μm.

To determine rheology in a paste, in each case 100 parts of the resultant polyvinyl chloride and 60 parts of diethylhexyl phthalate were mixed, and paste viscosities were determined after a storage time of 2 hours, at D=1.5 s⁻¹ and 45 s⁻¹ (Table 1).

### Inventive Example 2

4400 kg of deionized water were used as initial charge in a 15 m³ stirred vessel. The following were added to this

35 kg of alkylarylsulfonate
35 kg of stearyl monoethylene glycol ether
5.5 kg of dimyristyl peroxodicarbonate
5500 kg of vinyl chloride.

This mixture is stirred for 15 min at 25° C. and then passed under pressure through a rotor-stator disperser using 10.5 bar and a gap width of 0.5 mm in a 15 m³ stirred autoclave. The dispersion time here is 36 min, with throughput of 18 m³/h.

The reaction mixture is heated in the autoclave to the polymerization temperature of 52° C. The polymerization time is about 8 h.

The dispersion is worked up as in Inventive Example 1. The paste viscosity of the powder is found in Table 1.

### Inventive Example 3

4400 kg of deionized water were used as initial charge in a 15 m³ stirred vessel. The following were added to this

35 kg of alkylarylsulfonate
35 kg of stearyl monoethylene glycol ether
5.5 kg of dimyristyl peroxodicarbonate
3000 kg of vinyl chloride.

This mixture is stirred for 15 min at 25° C. and then passed under pressure through a rotor-stator homogenizer using 10.5 bar and a gap width of 0.5 mm in a 15 m³ stirred autoclave. The dispersion time here is 30 min, with throughput of 18 m³/h. 2500 kg of vinyl chloride are fed into the stirred autoclave prior to heating of the reaction mixture.

The reaction mixture is heated in the autoclave to the polymerization temperature of 52° C. The polymerization time is about 8 h.

The dispersion is worked up as in Inventive Example 1. The paste viscosity of the powder is found in Table 1.

### Comparative Example A

4400 kg of deionized water were used as initial charge in a 15 m³ stirred vessel. The following were added to this

55 kg of alkylarylsulfonate
55 kg of stearyl monoethylene glycol ether
5.5 kg of dimyristyl peroxodicarbonate
5500 kg of vinyl chloride.

This mixture is stirred for 15 min at 25° C. and then passed under pressure into a 15 m³ stirred autoclave by way of a piston homogenizer using homogenizing pressure of about 170 bar and throughput of 6 m³/h. The dispersion time here is 100 min.

The reaction mixture is heated in the autoclave to the polymerization temperature of 52° C. The polymerization time is about 8 h.

The dispersion is worked up as in Inventive Example 1. The paste viscosity of the powder is found in Table 1.

### Comparative Example B

4400 kg of deionized water were used as initial charge in a 15 m³ stirred vessel. The following were added to this

35 kg of alkylarylsulfonate
35 kg of stearyl monoethylene glycol ether
5.5 kg of dimyristyl peroxodicarbonate
5500 kg of vinyl chloride.

This mixture is stirred for 15 min at 25° C. and then passed under pressure into a 15 m³ stirred autoclave by way of a piston homogenizer using homogenizing pressure of about 170 bar and throughput of 6 m³/h. The dispersion time here is 100 min.

The reaction mixture is heated in the autoclave to the polymerization temperature of 52° C. The polymerization time is about 8 h.

A large amount of coagulated material is produced, making it impossible to work up the dispersion by way of spray drying.

### Comparative Example C

4400 kg of deionized water were used as initial charge in a 15 m³ stirred vessel. The following were added to this

35 kg of alkylarylsulfonate
35 kg of stearyl monoethylene glycol ether
5.5 kg of dimyristyl peroxodicarbonate
3000 kg of vinyl chloride.

This mixture is stirred for 15 min at 25° C. and then passed under pressure into a 15 m³ stirred autoclave by way of a piston homogenizer using homogenizing pressure of about 170 bar and throughput of 6 m³/h. 2500 kg of vinyl chloride are fed into the stirred autoclave prior to heating of the reaction mixture. The dispersion time here is 85 min.

The reaction mixture is heated in the autoclave to the polymerization temperature of 52° C. The polymerization time is about 8 h.

A large amount of coagulated material is produced, making it impossible to work up the dispersion by way of spray drying.

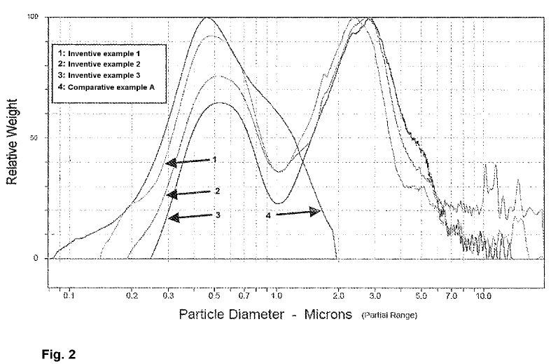

TABLE 1
Paste viscosities PVC/DEHP = 100/60 and volume-average
particle sizes Mᵥ (P1) and (P2) (see also FIG. 2)

| | | | |
|---|---|---|---|
| Inv. Ex./ | Pa · s | Mᵥ (P1) | Mᵥ (P2) |

| Comp. Ex. | D = 1.5 s⁻¹ | D = 45 s⁻¹ | [μm] | [μm] |
|---|---|---|---|---|
| 1 | 1.8 | 2.2 | 0.48 | 2.3 |
| 2 | 1.9 | 2.4 | 0.51 | 2.7 |
| 3 | 2.0 | 2.2 | 0.52 | 2.8 |
| A | 3.0 | 3.2 | 0.50 | — |
| B | — | — | — | — |
| C | — | — | — | — |

1. A process for preparation of pastable polymers composed of ethylenically unsaturated monomers by means of batch polymerization or copolymerization in a microsuspension process with use of dispersing equipment using the rotor-stator principle or (any) other homogenizing machine(s), where a bimodal primary particle size distribution of the polymer dispersion is generated via a single-stage process optimized with respect to dispersing pressure and shear gap width of the disperser system.

2. The process as claimed in claim 1, where the pastable polymer is a polymer of vinyl chloride or of a mixture of vinyl chloride with up to 30 percent by weight of copolymerizable monomers.

3. The process as claimed in claim 1, wherein the diameter of the primary particles is in the range from 0.05-1.0 μm for the population P1 and is in the range from 1.5-20 μm for the population P2.

4. The process as claimed in claim 1, wherein the ratio by volume of the particle populations P1 and P2 of the bimodal distribution is from 90:10 to 10:90, preferably in the range from 60:40 to 40:60.

5. The process as claimed in claim 1, wherein the amounts of emulsifier/coemulsifier used to stabilize the polymer dispersion are in each case from 0.3-2.0% by weight.

6. The process as claimed in claim 1, wherein mixtures having low content of emulsifier/coemulsifier are polymerized with amounts of emulsifier/coemulsifier which are in each case preferably from 0.4-0.8% by weight.

7. The process as claimed in claim 1, wherein only from 30-80% of the amount of monomer is transferred by way of the dispersing equipment into the polymerization reactor, and the remaining proportion is fed directly into the polymerization tank.

8. A pastable polymer, prepared by the process as claimed in claim 1.

9. A product, produced from a polymer as claimed in claim 8.
